(19) United States
(12) Patent Application Publication
(10) Pub. No.: US 2023/0042021 A1
(43) Pub. Date: Feb. 9, 2023

(54) Pet Kibble and Method to Make Pet Kibble

(71) Applicant: Anthony Lawler, Ridgefield, CT (US)

(72) Inventor: Anthony Lawler, Ridgefield, CT (US)

(21) Appl. No.: 17/831,472

(22) Filed: Jun. 3, 2022

Related U.S. Application Data
(60) Provisional application No. 63/230,992, filed on Aug. 9, 2021.

(51) Int. Cl. A23K 20/147; A23K 20/158; A23K 50/42; A23K 40/25; A23K 20/174

(52) U.S. Cl. CPC A23K 20/147; A23K 20/158; A23K 20/174; A23K 40/25; A23K 50/42

(57) ABSTRACT

A pet kibble containing from about 20 to 35 wt. % total protein, from about 10 to 15 wt. % edible fat, and from about 10 to 15 wt. % edible fiber. About 70 to 100 wt. % of the protein is plant-sourced. About 3 to 10 wt. % of edible fat is a combination of omega-6 and omega-3 oils. The pet kibble is essentially free of gluten, milk products, peanuts, tree nuts and wheat. The pet kibble is made by an extrusion process that includes flash baking the extrudate, wherein the flash baking is done at from about 450 to 525° F. for from about 30 to 50 seconds.

### CROSS-REFERENCE TO RELATED APPLICATIONS

This application claims the benefit of provisional patent application 63/230,992 filed Aug. 9, 2021, which is hereby incorporated by reference.

### STATEMENT REGARDING FEDERALLY SPONSORED RESEARCH

Not Applicable.

### APPENDIX

Not Applicable.

### BACKGROUND OF THE INVENTION

### Field of the Invention

The present invention relates to extruded edible pet food, and more particularly to pet kibble that is essentially free of gluten, milk products, peanuts, tree nuts, and wheat, and provides a nutritious balance of protein, carbohydrates, fats and fiber, and improved flavor. The pet kibble is prepared by an extrusion process that includes flash baking the extrudate.

### Related Art

The present invention provides the healthy combination of protein, carbohydrates, fats and fiber, along with micronutrients that pets need, our flash baked process reduces the glycemic index and adds the desired toasted effect pets find more palatable. Because some elderly pets are developing diabetes, it is desirable to have a pet kibble with the reduced glycemic index of this invention. This is done by a combination of selected healthy ingredients, an extrusion process of preparing the kibble, and adding a step of flash baking the extrudate kibble.

U.S. Pat. 5,132,133 discloses a method of making whole grain snack foods. The method includes extruding and treating whole grain mixtures. The method includes treating the extrudate with the combination of flash heating and flash frying. The process requires a frying step, wherein the present process does not. The claimed kibbles are prepared by the claimed method without frying the extrudate.

U.S. Pat. 7,829,128 discloses a method of making whole grain food composites by extruding a mixture of grains and water. The method fails to disclose the claimed flash baking of extrudate, and also contains gluten.

U.S. pat. application publication 2018/0180323A1 discloses a method of heating food using a combination of microwave and radiant heat at a temperature greater than 800 degrees F. Applicant's claimed flash heating step of an extrudate is not disclosed.

U.S. Pat. application publication US2019/0350227A1 discloses an extruded cat kibble that does not use flash baking.

U.S. Pat. 4,310,558 and WO2009/003721A1 disclose pet food prepared by extrusion that does not include flash baking the extrudate.

### SUMMARY OF THE INVENTION

The present invention is pet kibble comprising from about 20 to 35 wt. % total protein, from about 10 to 15 wt. % edible fat, and from about 10 to 15 wt. % edible fiber. From about 70 to 100 wt. % of the protein is plant-sourced. From about 3 to 10 wt. % of edible fat is a combination of omega-6 and omega-3 oils. The pet kibble is essentially free of gluten, milk products, peanuts, tree nuts and wheat. The pet kibble is made by an extrusion process that includes flash baking the extrudate, wherein the flash baking step is done at from about 450 to 525°F for from about 30 to 50 seconds. The kibble product contains from about 8 to 15 wt. % water. The process does not include frying of the extrudate.

The present invention further comprises a method of preparing a pet kibble comprising feeding dry feed into a mixer to form a dry feed mixture, wherein the dry feed comprises a protein source, a carbohydrate source, and a fat source. Heat and water and/or steam are used on the dry feed mixture to make a heated moistened mixture. The heated moistened mixture is treated to make a formed mixture, and the formed mixture is forced through a die in an extruder to form an extrudate. The extrudate is cut into pieces and flash baked at from 450 to 525° F. for from about 30 to 50 seconds to make toasted pieces. The toasted pieces are dried in a dryer at from about 250 to 325° F. from about 40 to 60 minutes to make the pet kibbles.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will become more fully understood from the detailed description and the accompanying drawings, wherein:

FIG. 1 discloses a prior art process for making pet kibble.

FIG. 2 discloses the present claimed process for making pet kibble.

### DETAILED DESCRIPTION OF THE PREFERRED EMBODIMENTS

The following description of the preferred embodiment(s) is merely exemplary in nature and is in no way intended to limit the invention, its application, or uses.

Kibble-type animal feeds, such as dog and cat foods, are dried, ready-to-eat pet food products. The kibbles may be formed by an extrusion process where the kibble raw materials are extruded under heat and pressure to form the pelletized kibble form. Extrusion technology provides a cheap and efficient method for formulating animal feed kibbles, particularly those having a starch matrix. The present invention is directed to an extrusion process that includes a flash baking step flowing cooking extrusion step, but preceding the drying step. The addition of this step provides a toasted texture and taste to the kibbles that is desirable and also reduced the glycemic index of the kibble.

The protein source may be a vegetable protein source, an animal protein source, or a mixture of these protein sources. Preferably, at least 70 wt. % of the protein is from a plant source. Suitable vegetable protein sources include soy protein, rice protein, corn protein, potato protein, pea protein, oat groats, brewer’s yeast, legumes, and the like. The present invention does not contain dairy or gluten sources of protein. These proteins may be provided in the form of flours, concentrates, and isolates as desired. Suitable animal protein sources are muscular or skeletal meat of mammals, poultry, and fish; meals such as meat meal, bone meal, fish meal, and poultry meal; by-products such as hearts, liver, kidneys, tongue and the like; and egg protein. Insect sources of protein are also suitable, such a cricket protein. In a preferred embodiment, the protein source is a mixture of rendered animal, insect, and vegetable proteins. The dried pet food conveniently contains about 20% to about 35% by weight of protein. From about 70 to 100 wt. % of the protein is plant-based protein.

Examples of vegetables as a carbohydrate source that can be incorporated into the subject pet kibble include, without limitation, potatoes, sweet potatoes, peas, carrots, zucchini, squash, beans, green beans, corn, hominy, spinach and mixtures thereof.

Examples of fruits as a carbohydrate source that might be included in the subject pet kibble include apple varieties such as Fuji, golden delicious, red delicious and granny smith, and various other fruits such as cranberries, blueberries, peaches, cantaloupe, pears, apricots, blackberries, papaya, strawberries, raspberries, tomatoes and mangos.

Examples of fat sources are animal fats such as chicken fat, duck fat, and the like; vegetable oils such as canola oil, flaxseed oil, olive oil, sunflower oil, or similar natured vegetable oils; and fish oils, particularly omega-6 and omega-3 oils. Omega-6 and omega-3 oils have particular health benefits for pets and are highly desirable. In a preferred embodiment, the present pet kibbles contain from about 3 to about 10 wt. % total omega 6-and omega-3 oils.

The pet kibble may also contain grains such as rice, barley and oatmeal; added vitamins and minerals; herbs and seasonings such as garlic, rosemary, salt, thyme, and palatants. Preferably, the palatants are added after extrusion as a coating.

Edible fiber sources include the fruits and vegetables in the pet kibble formulation, but additional fiber sources, such as fiber from miscanthus grass can also be added. Preferably, the pet kibble contains from about 3-9 wt. % fiber.

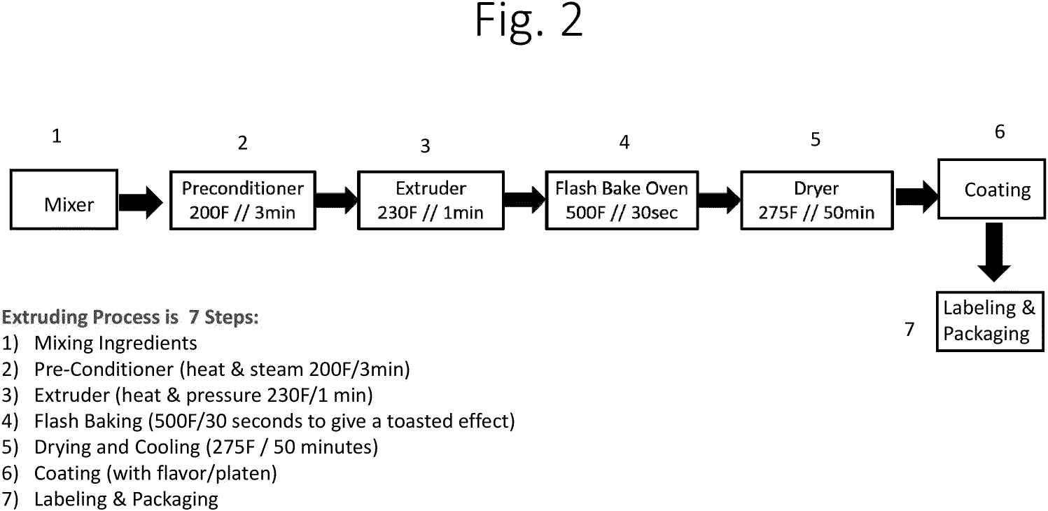

Referring to FIG. 2, the method of preparing the pet kibble involves an extrusion process, where in the process has the steps of dry feed fed into a Mixer (1) is prepared from a protein source, a carbohydrate source, a fat source, vitamins, and minerals. The dry feed mixture is then fed into a Preconditioner (2). In the Preconditioner, water or steam, or both, is mixed into the dry feed mixture. Further, liquid flavor components, such as flavor digests or tallow, may be mixed into the dry feed mix in the preconditioner. Sufficient water, steam, or liquid components are mixed into the feed mixture to raise the moisture content of the dry feed mixture to about from about 10 to 30 % by weight. Preferably the moisture content is about 20% by weight. The temperature of the mixture is raised in the preconditioner from about 190° F. to about 210° F. Preferably the temperature is about 200° F. and held for from about 1 to 5 min. Preferably the temperature is held for about 3 minutes. A suitable preconditioner is described in U.S. Pat. 4,752,139. The moistened feed leaving the Preconditioner is then fed into the Extruder (3). The Extruder may be any suitable cooking extruder. Suitable extruders may be obtained from Wenger Manufacturing Inc, Clextral SA, Bühler AG. The Extruder may be an extruder with high shear extrusion (SME 0.07 to 0.1). During passage through the Extruder, the moistened feed passes through a cooking zone, in which it is subjected to mechanical shear and is heated to a barrel temperature of up to from about 210 to 250° F. for from about 1 to 3 minutes. Preferably, the temperature is held about 230° F. for about 1 minute. The heated feed is fed into a forming zone. The gauge pressure in the forming zone is about 2000 kPa to about 7000 kPa as desired. If desired, water or steam, or both, may be introduced into the cooking zone. Further, during passage through the Extruder, the ingredients of the moistened feed form a mixture of protein, fats, fibers and other nutritional components.

The mixture leaving the Extruder is forced through a die forming an extrudate. Suitable dies may be obtained from Wenger Manufacturing (Sebetha, KS). The thickness of the extrudate may be varied depending on the type of food. Generally, kibbles for dogs will be three or more times larger than kibbles for cats. The orifice may have any suitable cross-section. Upon leaving the die, the extrudate is cut into pieces using blades. The blades are preferably arranged such that the resultant pieces will be sized suitably for the animal to be fed with the product. The individual extrudate pieces are baked in a Flash Bake Oven (4) at from about 450 to 525° F. Preferably, the temperature is about 500° F. and is held for about from 30 to 50 seconds. Preferably, the temperature is held about 30 seconds. The flash bake oven uses a combination of intense visible light and infrared energy to cook food rapidly and brown, or toast, the surface. After flash baking, the pieces pass through a dryer at from about 250 to 300° F. Preferably the dryer is about 275° F. The pieces are dried from about 40 to 60 minutes. Preferably, the pieces are dried for about 50 minutes. The dried kibbles contain from about 8 to 15 wt. % water. Preferably, the water content is about 10 wt. % water. Following drying, the kibbles are coated with flavoring agents. The flavor and nutritional content can be adjusted to suit a wide variety of nutritional needs.

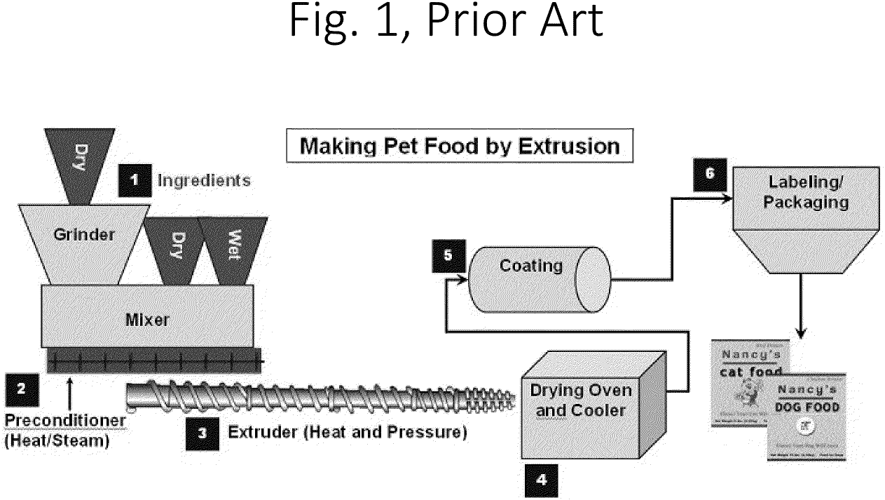

As shown in FIG. 1, prior art extrusion processes fail to provide the flash bake step which provides a more desirable pet kibble.

### Example 1

A mixture of protein sources, fruit, vegetables and fat sources were combined and processed using the process:
1) Mixing dry Ingredients
2) Pre-Conditioner (heat & steam 200° F./3 min)
3) Extruder (heat & pressure 230° F./1 min)
4) Flash Baking (500° F./30 seconds to give a toasted effect)
5) Drying and Cooling (275° F. / 50 minutes)
6) Coating (with flavor/platen)
7) Labeling & Packaging
   The kibble product composition, in wt. %:
   Crude Protein 25.5%
   Crude Fat 11.9%
   Crude Fiber 4.5%
   Water 12.0%
   Calcium 1.5%
   Phosphorus 0.9%
   Omega-3 Fatty Acids 2.4%
   Omega-6 Fatty Acids 2.5%

The combined Omega-3 and Omega-6 fatty acids made up 41.2 wt. % of the total crude fat.

### Control 1

The same ingredients and process steps were used as with Example 1. However, there was no flash baking of the extrudate.

Both Example 1 and Control 1 were offered to dogs. The dogs preferred Example 1 when compared to Control 1.

### Example 2

A mixture of protein sources, fruit, vegetables and fat sources were combined and processed using the same process as used in Example 1. The kibble product composition, in wt. %:
Crude Protein 27.0%
Crude Fat 11.2%
Crude Fiber 6.2%
Water 11.0%
Calcium 1.5%
Phosphorus 0.9%
Omega-3 Fatty Acids 1.11%
Omega-6 Fatty Acids 2.4%

The combined Omega-3 and Omega-6 fatty acids made up 31.3 wt.% of the total crude fat.

### Control 2

The same ingredients and process steps were used as with Example 2. However, there was no flash baking of the extrudate.

Both Example 2 and Control 2 were offered to dogs. The dogs preferred Example 2 when compared to Control 2.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A pet kibble comprising
from about 20 to 35 wt. % total protein;
from about 10 to 15 wt. % edible fat;
from about 10 to 15 wt. % edible fiber; and
from about 8 to 15 wt. % water;
wherein from about 70 to 100 wt. % of the protein is plant sourced;
wherein about 30 to 50 wt. % of edible fat is a combination of omega-6 and omega-3 oils;
wherein the pet kibble is essentially free of gluten, milk products, peanuts, tree nuts and wheat;
wherein the pet kibble is made by an extrusion process that includes flash baking the extrudate;
wherein the extrudate is not fried; and
wherein the flash baking step is done at from about 450 to 525° F. for from about 30 to 50 seconds.

2. The pet kibble of claim 1, wherein the flash baking step is about 30 seconds.

3. A method of preparing a pet kibble comprising;
feeding dry feed into a mixer to form a dry feed mixture;
wherein the dry feed comprises a protein source, a carbohydrate source, and a fat source; using heat and water and/or steam on the dry feed mixture to make a heated moistened mixture;
wherein the heated moistened mixture is treated to make a formed mixture;
forcing the formed mixture through a die in an extruder to form an extrudate;
cutting the extrudate into pieces;
flash baking the pieces at from 450 to 525° F. for from about 30 to 50 seconds to make toasted pieces;
drying the toasted pieces a dryer at from about 250 to 325° F. for from about 40 to 60 minutes to make the pet kibbles;
wherein the pet kibbles contain:
from about 7 to 12 wt. % water;
from about 20 to 35 wt. % total protein;
from about 10 to 15 wt. % edible fat; and
from about 10 to 15 wt. % edible fiber;
wherein from about 70 to 100 wt. % of the protein source is plant sourced;
wherein about 3 to 10 wt. % of edible fat is a combination of omega-6 and omega-3 oils;
wherein the extrudate is not fried; and
wherein the pet kibble is essentially free of gluten, milk products, peanuts, tree nuts and wheat.

4. The method of making pet kibble of claim 3, wherein sufficient water, steam, or liquid components are mixed into the dry feed mixture to raise the moisture content of the dry feed mixture to from about 10 to 30% by weight to form a moistened feed;
wherein the moistened mixture is heated to raise the temperature to from about 190 to 210° F. for about from about 1 to 5 minutes to form a heated, moistened mixture.

5. The method of making pet kibble of claim 4 wherein the extruder has a cooking zone; wherein the heated, moistened mixture is fed to the cooking zone;
wherein the cooking zone provides mechanical shear and heat of from about 220 to 240° F. for about 1 to 3 minutes to form a cooked mixture.

6. The method of making pet kibble of claim 5 wherein water or steam, or both, are introduced into the cooking zone.

7. The method of making pet kibble of claim 6 wherein the cooked mixture is fed to a forming zone; and
wherein the forming zone has a pressure of about 2000 kPa to about 7000 kPa to make the formed mixture which is fed through a die into the extruder.

8. A method of preparing a pet kibble comprising:
feeding dry feed into a mixer to form a dry feed mixture;
wherein the dry feed comprises a protein source, a carbohydrate source, a fat source, vitamins, and minerals;
feeding the dry feed mixture into a preconditioner;
wherein in the preconditioner, water or steam, or both, and liquid flavor components are mixed into the dry feed mixture;
wherein sufficient water, steam, or liquid components are mixed into the feed mixture to raise the moisture content of the dry feed mixture to from about 10 to 30% by weight to form a moistened feed;
wherein the moistened mixture is heated in the preconditioner to raise the temperature to from about 190 to 210° F. for about from about 1 to 5 minutes;
feeding the heated, moistened mixture to an extruder;
wherein the extruder has a cooking zone;
wherein the cooking zone provides mechanical shear and heat of from about 220 to 240° F. for about 1 to 3 minutes to form a cooked mixture;
wherein water or steam, or both, are introduced into the cooking zone;
feeding the cooked mixture to a forming zone;
wherein the forming zone has a pressure of about 2000 kPa to about 7000 kPa to make a formed mixture;
forcing the formed mixture through a die to form an extrudate;
cutting the extrudate into pieces using blades;
flash baking the pieces in a flash bake oven at from 450 to 525° F. for from about 30 to 50 seconds to make toasted piece;
drying the toasted pieces a dryer at from about 250 to 325° F. for from about 40 to 60 minutes to make the pet kibbles;
wherein the pet kibbles contain from about 7 to 12 wt. % water;
from about 20 to 35 wt. % total protein;
from about 10 to 15 wt. % edible fat; and
from about 10 to 15 wt. % edible fiber;
wherein from about 70 to 100 wt. % of the protein is plant sourced;
wherein about 3 to 10 wt. % of edible fat is a combination of omega-6 and omega-3 oils;
wherein the extrudate is not fried; and
wherein the pet kibble is essentially free of gluten, milk products, peanuts, tree nuts and wheat.

9. The method of claim 7, wherein the plant source of protein is selected from the group consisting of soy protein, rice protein, corn protein, potato protein, pea protein, oat groats, brewer’s yeast, legumes, and combinations thereof.

10. The method of claim 8, wherein the plant source of protein is selected from the group consisting of soy protein, rice protein, corn protein, potato protein, pea protein, oat groats, brewer’s yeast, legumes, and combinations thereof.

11. The pet kibble of claim 1, wherein the plant source of protein is selected from the group consisting of soy protein, rice protein, corn protein, potato protein, pea protein, oat groats, brewer’s yeast, legumes, and combinations thereof.

12. The method of claim 9, wherein the carbohydrate source comprises vegetables wherein the vegetables are selected from the group consisting of potatoes, sweet potatoes, peas, carrots, zucchini, squash, beans, green beans, corn, hominy, spinach and combinations thereof.

13. The method of claim 10, wherein the carbohydrate source comprises vegetables wherein the vegetables are selected from the group consisting of potatoes, sweet potatoes, peas, carrots, zucchini, squash, beans, green beans, corn, hominy, spinach and combinations thereof.

14. The pet kibble of claim 11, wherein the carbohydrate source comprises vegetables wherein the vegetables are selected from the group consisting of potatoes, sweet potatoes, peas, carrots, zucchini, squash, beans, green beans, corn, hominy, spinach and combinations thereof.

15. The method of claim 12, wherein the carbohydrate source comprises fruits, wherein the fruits are selected from the group consisting of apples, cranberries, bluebernes, peaches, cantaloupe, pears, apricots, blackberries, papaya, strawberries, raspberries, tomatoes, mangos, and combinations thereof.

16. The method of claim 13, wherein the carbohydrate source comprises fruits, wherein the fruits are selected from the group consisting of apples, cranberries, bluebernes, peaches, cantaloupe, pears, apricots, blackberries, papaya, strawberries, raspberries, tomatoes, mangos, and combinations thereof.

17. The pet kibble of claim 14, wherein the carbohydrate source comprises fruits, wherein the fruits are selected from the group consisting of apples, cranberries, blueberries, peaches, cantaloupe, pears, apricots, blackberries, papaya, strawberries, raspberries, tomatoes, mangos, and combinations thereof.

18. The method of claim 15, wherein the pet kibble further comprises grains, vitamins, minerals, herbs, seasonings, and palatants.

19. The method of claim 16, wherein the pet kibble further comprises grains, vitamins, minerals, herbs, seasonings, and palatants.

20. The pet kibble of claim 17, wherein the pet kibble further comprises grains, vitamins, minerals, herbs, seasonings, and palatants.
